(19) United States
(12) Patent Application Publication
(10) Pub. No.: US 2014/0350946 A1
(43) Pub. Date: Nov. 27, 2014

(54) Methods for Tracking Workflow in Pharmacies Involving Compound Operations

(71) Applicant: Paul P. Klomp, Sugar Land, TX (US)

(72) Inventor: Paul P. Klomp, Sugar Land, TX (US)

(73) Assignee: PROFESSIONAL COMPOUNDING CENTERS OF AMERICA, Houston, TX (US)

(21) Appl. No.: 13/900,347

(22) Filed: May 22, 2013

(51) Int. Cl. G06Q 10/06; G06Q 50/22

(52) U.S. Cl. CPC G06Q 10/0633; G06Q 50/22
USPC 705/2

(57) ABSTRACT

The present disclosure relates to a workflow method that may be utilized in pharmacies involving compounding operations. The method may classify prescriptions depending on the need to compound them, and may thereafter assign the location of the different pharmaceutical compositions for pharmacy personnel to retrieve them, or may locate the different chemicals needed to compound the required pharmaceutical compositions if the desired pharmaceutical compositions are not available in inventory. The present workflow method may manage an unlimited number of activities depending on the pharmacy workload, pharmacy layout, and types of pharmaceutical compositions. The present workflow method may increase accuracy and efficiency of pharmaceutical operations.

### CROSS-REFERENCE TO RELATED APPLICATIONS

N/A

### FIELD OF THE DISCLOSURE

The present disclosure relates generally to pharmaceutical operations, and more specifically to a method for tracking workflow in pharmacies involving compounding operations.

### BACKGROUND INFORMATION

Retail, hospital, long-term care, and mail-order pharmacies exist to fulfill patient prescription orders. In order to fulfill patient prescriptions, pharmacies may typically stock and manage a large and extensive inventory of pharmaceutical compositions and other healthcare-related products.

A typical pharmacy workflow may include a data entry clerk inputting prescription information to a system, after which each adjudicated order may be held in a database on a pharmacy computer for fulfillment. Then, a pharmacist or filling technician fills each prescription in the prescription order by retrieving the appropriate medications and taking them to a filling workstation. In the filling workstation, the appropriate number of medications are metered into a container and labeled in accordance with the prescription order. In cases where the medications are not available in the inventory, the pharmaceutical composition may need to be compounded, such that the prescription order may be fulfilled. Finally, the prescription order is verified by a pharmacist to ensure that the correct medication is in each container, and the medication is packaged and delivered to a patient.

Most of these actions may be tracked and managed with an information system. However, current workflow systems do not include a tracking and managing method for compounded pharmaceutical compositions, forcing these pharmacies to rely upon common pharmaceutical workflow systems. This may lead to significant patient waiting time and dispensing errors, considered to be two major quality indicators for the process of medication dispensing. Accuracy and efficiency of compounding pharmacy workflow methods are considered to be a major concern in pharmaceutical operations.

### SUMMARY

The present disclosure relates to a workflow method that may be utilized in pharmacies involving compounding operations. The method may be performed with a workflow information system employing pharmacy computers in a pharmacy, and may involve activities performed by different pharmacy personnel in different areas of the pharmacy.

The workflow method may include receiving customer prescription orders; entering the prescription orders into the workflow information system for data storage in a database; displaying the prescription orders in a computer screen with the workflow information system; checking if the pharmaceutical compositions in the prescription order are available in the inventory for analyzing if compounding operations may be necessary; distributing the different prescriptions to selected locations; compounding, if needed, the required pharmaceutical compositions or retrieving the pharmaceutical compositions if available in the inventory; packaging the pharmaceutical compositions; printing and affixing labels on the pharmaceutical compositions; checking if the complete prescription order has been correctly fulfilled; and scanning and delivering the pharmaceutical compositions to the customer at a sales station.

When compounding the pharmaceutical compositions, the workflow method may include displaying which pharmaceutical compositions may need to be compounded, compounding information, pharmaceutical composition application, storage location of each chemical, the quantity in inventory, the quantity required, the expiration dates of the chemicals, operational parameters, mixing instructions, quality assurance checks to be done, among others. Other instructions may as well be displayed, such as the need to call a doctor if mixing instructions are not clear, or the need to call a patient for further questions. All of this information may be available in the workflow information system and may be accessed at a compounding computer in a compounding station.

Employing the workflow method described in the present disclosure may increase accuracy of compounding operations, and may reduce time required for performing compounding activities and other pharmaceutical operations.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 illustrates a pharmacy layout including a compounding area, according to the prior art.

FIG. 2 is a flowchart of a workflow method for a pharmacy including compounding activities, according to an embodiment.

### DETAILED DESCRIPTION

In the following detailed description, reference is made to the accompanying drawings, which form a part here. In the drawings, which are not to scale or to proportion, similar symbols typically identify similar components, unless context dictates otherwise. The illustrative embodiments described in the detailed description, drawings and claims, are not meant to be limiting. Other embodiments may be used and/or other changes may be made without departing from the spirit or scope of the present disclosure.

### Definitions

As used here, the following terms may have the following definitions:

“Pharmaceutical composition” refers to a pharmaceutical dosage form, such as a tablet, capsule, and solution, among others, generally including an active ingredient in association with inactive ingredients.

“Compounding” refers to a process for preparing personalized medications for patients, involving communication between a compounding pharmacist with a patient and a prescriber in order to customize a medication that may meet the patient's specific needs.

“Workflow method” refers to a sequence of concatenated steps involving pharmaceutical operations, in which a prescription order is fulfilled by pharmacy personnel until one or more pharmaceutical compositions are delivered to a customer.

“Workflow information system” refers to a computer software that uses a workflow method for tracking and managing different activities involved therein.

“Prescription” refers to an order written by a health professional for the preparation and administration of a pharmaceutical composition or other treatment to a patient.

“Prescription orders” refer to one or more prescriptions by a health professional to be dispensed by a pharmacy for administration to a patient.

### Description

The present disclosure relates to a workflow method that may be suitable for tracking pharmaceutical operations including compounding activities. The workflow method may assign pharmaceutical compositions to be compounded, including the location where each chemical may be found and the mixing instructions for the pharmaceutical compositions.

### Pharmacy Layout

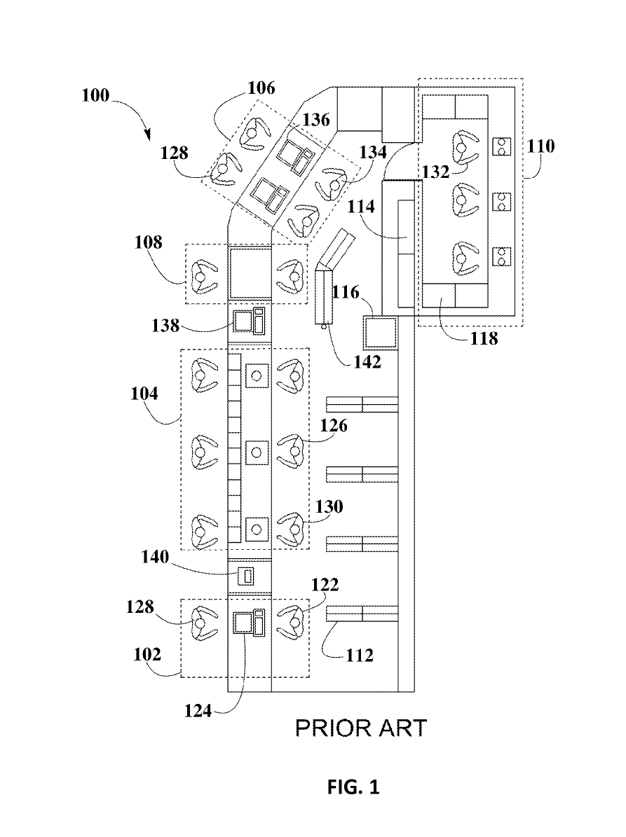

FIG. 1 shows a typical pharmacy 100 including compounding activities and employing a prior art pharmacy workflow. Locations and dimensions of areas of pharmacy 100 are not limited by FIG. 1, and may vary according to the different needs of pharmacy 100. In pharmacy 100, the workflow system may neither assign nor track compounding activities, which may lead to inaccuracy and less efficiency when fulfilling prescription orders.

Accordingly, pharmacy 100 may include an order entry station 102, a filling/checking station 104, a payment station 106, a consultation station 108, and a compounding station 110. Additionally, pharmacy 100 may be provided with one or more shelves 112 serving as pharmaceutical composition storage locations. Each shelf 112 may typically be about 6 to about 8 feet high, and may include a plurality of spaced-apart horizontally-oriented compartments. Pharmaceutical compositions and other products may be stored in each shelf 112 pending manual retrieval for fulfillment of a prescription order. Other storage locations within pharmacy 100 may include a restricted-access cabinet 114 for storage of narcotics and other controlled medications; a refrigerator 116 for storage of perishable pharmaceutical compositions; and different compounding storages 118 within compounding station 110.

Pharmacy 100 may include different personnel with different levels of responsibility, including one or more data entry clerks 122, which may enter prescription order information to a workflow information system via data entry computer 124 at order entry station 102; one or more registered pharmacists 126, which may be responsible for fulfillment of prescription orders and for verification of each prescription order before providing them to customers 128; one or more filling technicians 130, which may assist registered pharmacists 126 in fulfilling each prescription order, and which may, also along with registered pharmacists 126, provide health-care-related information to customers 128 at consultation station 108; one or more compounding pharmacists 132, which may compound pharmaceutical compositions in compounding station 110 when these are not available in the inventory; and one or more sales clerks 134, which may process sales transactions at payment station 106 using sales computers 136.

Workflow at pharmacy 100 may be summarized in the following manner. Data entry clerk 122 may input a prescription order to the workflow information system at order entry station 102 via data entry computer 124, then each adjudicated prescription order may be held in a database and displayed on pharmacy computer 138 at filling/checking station 104 for fulfillment, typically on a first in first out (“FIFO”) basis. Labels for attachment to each container associated with the prescription order may be printed on printer 140. Registered pharmacists 126 or filling technicians 130 may select the prescription order next in line to be filled, to subsequently check availability of pharmaceutical compositions in the inventory using pharmacy computer 138. The prescriptions making up the prescription orders may not be arranged in any particular sequence.

Registered pharmacists 126 or filling technicians 130 may then fill each prescription in the prescription order. In cases in which pharmaceutical compositions in the prescriptions are not available in inventory, registered pharmacists 126 or filling technicians 130 may take the prescription order to a compounding pharmacist 132 in compounding station 110, which may combine chemicals located in compounding storages 118 to produce the required pharmaceutical composition in the prescription. When compounding, compounding pharmacists 132 may need to call the prescribing doctor for specific compounding instructions, which may assist on ensuring that the correct pharmaceutical compositions are being manufactured, or may even need to call the patient for further information about his health condition or other data.

If pharmaceutical compositions are available, each prescription in the prescription order may be filled by walking to one of the different storage locations, including shelves 112, refrigerator 116, or cabinet 114, among others. Afterwards, registered pharmacists 126 or filling technicians 130 may retrieve the appropriate pharmaceutical composition, which may be in bulk-form or in prepackaged form. Either compounded or already in inventory, pharmaceutical compositions may then be taken to filling/checking station 104, where appropriate number of pharmaceutical compositions may be metered into a container in accordance with the prescription order. The corresponding label may be placed in each container.

This process may be repeated until each prescription in the prescription order is fulfilled. The prescription order may then be verified by registered pharmacists 126 at filling/checking station 104 to ensure that the correct medication is in each container. The fulfilled order may then be placed in a bag or other package and may be held at a “will call” area 142 near payment station 106. Sales clerk 134 may process the transaction and may deliver the packaged prescription order to customer 128 at payment station 106.

Employing the workflow described for pharmacy 100, problems related to accuracy and efficiency regarding compounding operations may be encountered, because generally, current software programs in compounding pharmaceutical workflows may not track and manage compounding operations properly. This may increase pharmaceutical composition traceability problems, and may also increase compounding operation times.

### Pharmacy Workflow Method

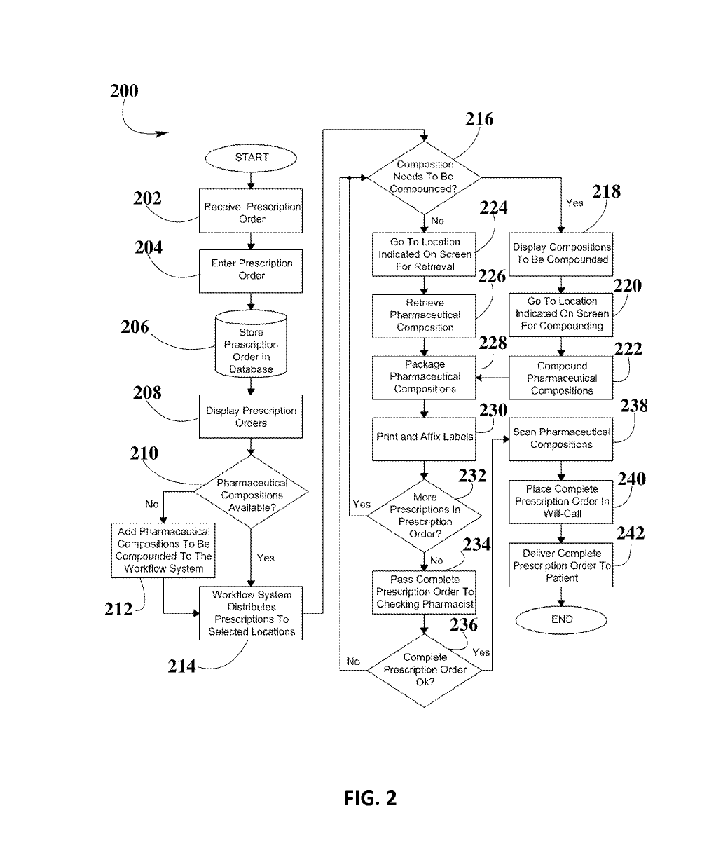

FIG. 2 illustrates a flowchart of workflow method 200 according to embodiments of the present disclosure. Reference to FIG. 1 may also be made in the following explanation. Accordingly, workflow method 200 may begin by receiving a customer/patient order 202, then, a data entry clerk 122 may enter the prescription order 204 into the workflow information system for storing prescription order in database 206. Pharmacy computer 138 may then display prescription orders 208, which may be done according to different categories, including by patient, by reception sequence, by workstation class. Subsequently, workflow information system employing workflow method 200 may check if pharmaceutical compositions in prescription orders are available in inventory 210. If pharmaceutical compositions are not available in inventory, workflow method 200 may add pharmaceutical compositions to be compounded 212 to the workflow information system. Subsequently, workflow method 200 employed in workflow information system may distribute prescriptions to selected locations 214, which may depend on the pharmaceutical compositions availability, type and operational parameters of the pharmaceutical composition, layout of pharmacy 100, and ingredients necessary to compound them, among others.

Workflow method 200 may continue by checking if the pharmaceutical composition needs to be compounded 216. In the case of needing to compound pharmaceutical compositions, pharmaceutical compositions to be compounded may be displayed 218, including information such as pharmaceutical composition name, pharmaceutical composition application, storage location of each chemical, the quantity in inventory, the quantity required, expiration dates of chemicals, operational parameters, mixing instructions, among others. Other instructions, such as the need to call a doctor if mixing instructions are not clear, or the need to call a patient for further questions, may be shown when pharmaceutical compositions to be compounded are displayed 216. All of this information may be available in the workflow information system and may be accessed at a compounding computer (not shown in the layout of pharmacy 100 from FIG. 1) in compounding station 110. A compounding pharmacist 132 may proceed by going to the location indicated on screen for compounding 220 and then by compounding the pharmaceutical composition 222 assigned by the workflow information system employing workflow method 200. If required, a compounding pharmacist 132 may call a prescribing doctor for further instructions for compounding the pharmaceutical compositions 222, or may need to call the patient for further information about his health condition or other data.

If the pharmaceutical composition does not need to be compounded, a filling technician 130 or registered pharmacist 126 may go to the location indicated on the screen for retrieval 224 to thereafter retrieve the pharmaceutical composition 226 related to the prescription in the prescription order. After either the compounded pharmaceutical composition or the retrieved pharmaceutical compositions are in possession of a pharmacist, pharmaceutical compositions may be packaged 228 in suitable containers, such as bottles, vials, and unit dosage packages, among others, after which labels may be printed and affixed 230 on respective containers for each pharmaceutical composition. Printing of labels may be performed employing printer 140, while the packaging of the pharmaceutical compositions may be performed by a filling technician 130 or registered pharmacist 126.

Workflow method 200 may proceed by checking if there are more prescriptions in the prescription order 232, in which case workflow method 200 may return to checking if the pharmaceutical composition needs to be compounded 216. If there are no more prescriptions in the prescription order, a complete prescription order may be passed to a registered pharmacist 234, which may then check if the complete prescription order has been correctly fulfilled 236, in which case registered pharmacist 126 may then scan pharmaceutical compositions 238 and place the complete prescription order in a will call station 240. Finally, a sales clerk 134 may deliver the complete prescription order 242 to a customer 128 at payment station 106. On the other hand, if the complete prescription order has not been correctly fulfilled, a filling technician 130 or registered pharmacist 126 may again check if the pharmaceutical composition needs to be compounded 216, after which the subsequent steps of workflow method 200 may take place until the prescription order has been correctly fulfilled and delivered to the customer.

The present workflow method 200 may permit pharmacy personnel to input and manage an unlimited number of activities depending on the complexity of the pharmacy operations, layout of pharmacy 100. Furthermore, the present workflow method 200 may reduce compounding times, and therefore pharmaceutical operation times, in addition to increasing accuracy of compounding operations.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for controlling workflow involving a pharmaceutical composition, the method comprising:
receiving into a workflow information system at least one customer prescription order;
providing a non-transitory computer readable storage medium having encoded thereon computer executable instructions for providing a graphical user interface capable of displaying the at least one customer prescription order;
querying at least one inventory database associated with the workflow information system to determine availability of the at least one customer prescription order;
retrieving at least one pharmaceutical composition in accordance with the at least one customer prescription order and associating each retrieval of the at least one pharmaceutical composition with at least one unique identifier associated with the at least one customer prescription order;
verifying the respective association of each of the at least one pharmaceutical composition with the at least one customer prescription order in accordance with each of the at least one unique identifier; and
delivering the verified at least one customer prescription order to a designated location.

2. The method of claim 1, further comprising at least one inventory of a plurality of the at least one pharmaceutical composition and an inventory database suitable for tracking the at least one inventory.

3. The method of claim 2, wherein the designated location is remote from the at least one inventory.

4. The method of claim 1, wherein one of the at least one retrieved pharmaceutical composition is compounded.

5. The method of claim 4, wherein the workflow information system provides compounding information for the compounded at least one retrieved pharmaceutical composition.

6. The method of claim 2, further comprising:
providing, from the at least one inventory database, at least one selected from the group consisting of a storage location of the at least one pharmaceutical composition, a quantity of available at least one pharmaceutical composition, an expiration of the at least one pharmaceutical composition, mixing instructions of the at least one pharmaceutical composition, and quality assurance checks related to the at least one pharmaceutical composition.

7. The method of claim 1, wherein the workflow information system further comprises customer specific information comprising the at least one customer prescription order.

8. The method of claim 7, wherein the customer specific information comprises prescribing physician information.

9. The method of claim 2, wherein the at least one inventory is remote from the inventory database suitable for tracking the at least one inventory.

10. The method of claim 1, wherein at least said receiving, providing, querying and retrieving steps comprise a decreasing of complexity for managing said delivering step.

11. The method of claim 1, wherein at least said verifying step comprises a increasing of accuracy fosaid delivering step.
